(19) United States
(12) Patent Application Publication
(10) Pub. No.: US 2026/0233545 A1
(43) Pub. Date: Aug. 13, 2026

(54) DECORATED ARTICLE WITH SURFACE AREAS HAVING DIFFERENT GLOSS LEVEL

(71) Applicant: JAMES HARDIE TECHNOLOGY LIMITED, Dublin 2 (IE)

(72) Inventors: Prem UPADHYAY, Rosehill, New South Wales (AU); Sagarika RICHARDS, Rosehill, New South Wales (AU); Milton O'CHEE, Rosehill, New South Wales (AU); Derrick ROBERTS, Rosehill, New South Wales (AU)

(21) Appl. No.: 19/469,288

(22) PCT Filed: Mar. 28, 2024
(86) PCT No.: PCT/IB2024/053002

§ 371 Date: Sep. 25, 2025

(30) Foreign Application Priority Data
Mar. 31, 2023 (AU) 2023900920

(51) Int. Cl. B41M 7/00; B41M 5/00

(52) U.S. Cl. CPC B41M 7/0081; B41M 5/0047; B41M 2205/42

(57) ABSTRACT

A method of manufacturing an improved decorated article, comprising: (a) preparing a decorative image layer in digital format comprising: i. preparing a decorative image layer comprising a first image area defining a matrix portion, and at least one second image area, each second image area defining a discrete decorative element, the first image area and each second image area together defining a finite image area; ii. creating a first digital selection layer, and defining a first selected portion corresponding to the first image area of decorative image layer; iii. creating at least one second digital selection layer and defining at least one second selected portion, each second selection portion corresponding to a discrete decorative element in decorative image layer, and together corresponding to the second area of decorative image layer; wherein the first area of the first digital layer and the second area of the second digital layer together correspond to the finite area of the digital decorative image layer; (b) providing a prepared substrate comprising at least a first major face, (c) digitally printing the decorative image layer to at least a portion of the first major face; (d) using first selected portion of first digital selection layer 160 to direct application of a first clear coating composition onto prepared substrate, superimposed on and corresponding to, the first area, and curing the first clear coating to a first gloss level; and (e) using each second portion of the at least one second digital selection layer to apply a second clear coating composition onto prepared substrate, superimposed on and corresponding to, the second area, and curing the second clear coating to a second gloss level.

### FIELD OF THE INVENTION

The present disclosure generally relates to decorated articles, and in particular decorated articles for use as a building product for external cladding or internal lining products in buildings.

### BACKGROUND TO THE INVENTION

Any discussion of the prior art throughout the specification should in no way be considered as an admission that such prior art is widely known of forms part of the common general knowledge in the field.

Articles, such as building products, having decorative images applied as surface decoration are known. In general, these products have a decorative image layer applied to the surface of the building product, and the image layer is protected by a clear top coat layer to provide protection against mechanical damage like scratching, and against environmental damage like fading due to UV light exposure.

The top, generally clear, coating layer in these products has a preselected gloss level, to suit both the manufacturer's available technology and customer driven primary aesthetic choices. However, these coatings are applied to provide a uniform surface finish, generally with a predetermined gloss level which can detract from a realistic or authentic replication of aesthetic visual features of the decorative image used.

### SUMMARY OF THE INVENTION

It is an object of the present invention to overcome or ameliorate at least one of the disadvantages of the prior art, or to provide a useful alternative.

It may be desirable to provide an improved decorated article that has a top coating layer that can distinguish preselected decorative elements of a decorative image to provide an improved realistic or authentic look to a decorative image.

According to the present disclosure there is also provided a method of making an improved decorated article for use as cladding on a building, as set out in appended claims 1 to 8.

According to the present disclosure there is provided an improved decorated article, suitable for use as a building product as an external cladding or internal lining product as set out in appended claims 9 to 26.

For the purposes of this specification, the term ‘comprise’ shall have an inclusive meaning. Thus it is understood that it should be taken to mean an inclusion of not only the listed components it directly references, but also non specified components. Accordingly, the term ‘comprise’ is to be attributable with as broad an interpretation as possible and this rationale should also be used when the terms ‘comprised’ and/or ‘comprising’ are used.

Further aspects or embodiments of the present invention will become apparent from the ensuing description which is given by way of example only.

In one embodiment, there is provided a method of manufacturing an improved decorated article, comprising:
a. preparing a decorative image layer in digital format comprising:
   i. preparing a decorative image layer comprising a first image area defining a matrix portion, and at least one second image area, each second image area defining a discrete decorative element, the first image area and each second image area together defining a finite image area;
   ii. creating a first digital selection layer, and defining a first selected portion corresponding to the first image area of decorative image layer;
   iii. creating at least one second digital selection layer and defining at least one second selected portion, each second selection portion corresponding to a discrete decorative element in decorative image layer, and together corresponding to the second area of decorative image layer,
   wherein the first area of the first digital layer and the second area of the second digital layer together correspond to the finite area of the digital decorative image layer;
b. providing a prepared substrate comprising at least a first major face, digitally printing the decorative image layer to at least a portion of the first major face;
c. using first selected portion of first digital selection layer to direct application of a first clear coating composition onto prepared substrate, superimposed on and corresponding to, the first area, and curing the first clear coating to a first gloss level; and
d. using each second portion of the at least one second digital selection layer to apply a second clear coating composition onto prepared substrate, superimposed on and corresponding to, the second area, and curing the second clear coating to a second gloss level.

The advantage of this is that the first and second digital layers are superimposed over the digital image layer and then selectively cured to different gloss levels to enhance sections of the digital image layer and provide an improved decorative effect.

In one embodiment, the cured first clear coating layer has a different gloss level to the cured second clear coating layer, and any subsequent clear coating layer.

In one embodiment, the first coating layer is cured to a lower gloss level than the second clear coating layer.

In one embodiment, the first clear coating layer is cured to a gloss level less than 20 Gloss Units.

In one embodiment, the first clear coating layer and at least the second clear coating layer do not substantially overlap.

In one embodiment, the present disclosure provides an improved decorated article, made using the method, for use as cladding on a building, comprising:
a. a prepared substrate comprising at least a first major face;
b. a decorative image applied to at least a portion of the first major face to form a decorative image layer, the decorative image layer comprising a first image area and at least one second image area;
c. a first clear coating layer applied to the first image area of the decorative image layer and cured to a first gloss level; and
d. at least a second clear coating layer applied to at least one discrete location on the second image area of the decorative image layer and cured to a second gloss level,
characterised in that the first clear coating layer is applied to a location defined by a first selected portion of first selection layer and the second clear coating layer is applied to at least one discrete location, each discrete location defined by a second selected portion of at least a second selection layer, and the at least a second clear coating layer is superimposed over at least one corresponding second image area to provide a visually distinct appearance.

In one embodiment, the decorative image comprises at least one natural material.

In one embodiment, the natural material is natural stone, plant and/or animal based.

In one embodiment, the decorative image comprises at least one manufactured material such as concrete, synthetic stone, metal, polymer, composite materials, textiles, ceramics and the like.

In one embodiment, the decorative image comprises at least one work of figurative art, abstract art, digital art, cartooning, text, symbols, regular shapes, and irregular shapes.

In one embodiment, at least one second image area has an irregular shape.

In one embodiment, at least one second image area has a regular shape.

In one embodiment, the gloss level of the cured surface of the second clear coating layer is higher than the gloss level of the cured surface of the first clear coating layer.

In one embodiment, the gloss level of the cured surface of the first clear coating is less than 20 Gloss Units.

### BRIEF DESCRIPTION OF THE DRAWINGS

Certain embodiments of the present disclosure will now be described, by way of example only, with reference to the accompanying drawings. From figure to figure, the same or similar reference numerals are used to designate similar components of an illustrated embodiment.

FIG. 1 shows a cross-sectional side view of an embodiment of an improved decorated article according to the present disclosure;

FIG. 2A shows a decorative image layer having a series of decorative star shapes distributed in a plain matrix, each star shape providing a discrete decorative element;

FIG. 2B shows a first digital selection layer showing the plain matrix area surrounding the star shapes has been selected as the first selected layer portion of the first image area;

FIG. 2C shows a second digital selection layer where the star shapes selected as the second digital layer selection portion of the second image area;

FIG. 3 shows a flow chart of the method of manufacture of an improved decorated article according to the present disclosure;

FIG. 4A shows a decorative image layer in greyscale of a polished veined marble section;

FIG. 4B shows a first digital selection layer in which the first image area is shown in black; and

FIG. 4C shows a second digital selection layer in which the discrete decorative elements comprising the second image area are shown in black.

### DETAILED DESCRIPTION

In the description which follow, like parts may be marked throughout the specification and drawings with the same reference numerals. The drawing figures are not necessarily to scale and certain features may be shown exaggerated in scale or in somewhat generalized or schematic form in the interest of clarity and conciseness.

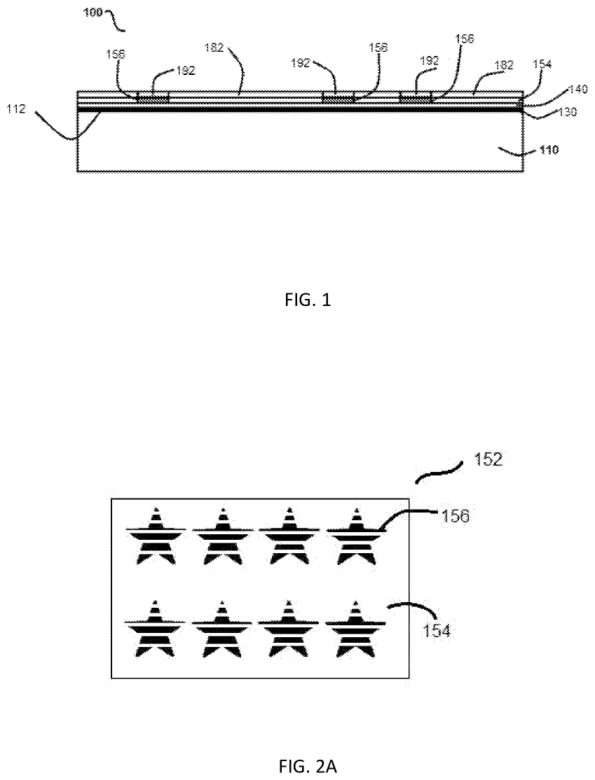

Referring now to the drawings, in FIG. 1 there is shown a cross-sectional side view of an improved decorated article 100 manufactured according to method 300 of the present disclosure, the method comprising: preparing a decorative image 150 in digital format comprising: preparing a decorative image layer 152 comprising a first image area 154 defining a matrix portion, and at least one second image area 156, each second image area defining a discrete decorative element, the first image area 154 and each second image area 156 together defining a finite image area; creating a first digital selection layer 160, and defining a first selected portion 162 corresponding to the first image area 154 of decorative image layer 152; creating at least one second digital selection layer 170 and defining at least one second selected portion 172, each second selection portion 172 corresponding to a discrete decorative element in decorative image layer 152, and together corresponding to the second image area 156 of decorative image layer; wherein the first selected portion 162 of first digital layer 160 and the second selected portion 172 of second digital layer 170 together correspond to the finite area of the digital decorative image layer 152; providing a prepared substrate 114 comprising at least a first major face 112, digitally printing decorative image layer 152 to at least a portion of the first major face 112; using first selected portion 162 of first digital selection layer 160 to direct application of a first clear coating composition 180 onto prepared substrate 114, superimposed on and corresponding to, the first image area 154, and curing the first clear coating layer 182 to a first gloss level; and using each second selected portion 172 of the at least one second digital selection layer 170 to apply a second clear coating composition 190 onto prepared substrate 114, superimposed on and corresponding to, the second image area 156, and curing the second clear coating layer 192 to a second gloss level.

Decorative image layer 152, first digital selection layer 160 and at least a second digital selection layer 170 are prepared using image editing software. First digital selection layer 160 and second digital selection layer 170 are used to define the portions of digital image layer 152 that will have first clear coating layer 182, and at least a second clear coating layer 192 respectively applied.

In one embodiment, decorative digital image 150 comprises a multi-colour image. In an alternate embodiment, decorative image 150 comprises a single colour image. Decorative image 150 may comprise an image of a natural material such as a stone, wood, a manufactured materials such as metal, concrete, ceramic or textile, or may be a digitally created image that has no real world equivalent. In each decorative image 150 whether comprising a single colour, or multiple colours, there must be at least one second image area 156 in the image that comprises a visually distinct feature such as gloss level or opacity, and the like.

A decorative image may be prepared by any commonly known means, for example, film photography with subsequent conversion to a digital image format by scanning, digital photography, direct digital scanning of the desired subject matter, direct digital image creation, and the like. Decorative image 150 is prepared for digital printing in the usual way by uploading to an image editing software program and sizing to the desired size, colour correcting the image, adjusting lighting effects, and so on until the image is optimised to meet the user's requirements.

In one embodiment of an improved decorated article 100, decorative image 150 is of a natural material such as a natural stone. Suitable natural stone types include granite, marble, slate, sandstone, quartzite, limestone and any other stone type that can be cut or split into a typical wall panel size or cut into smaller pieces and assembled to form a mosaic, tessellation, stacked arrangement or similar. Decorative images could include combinations of different stone types and arrangements.

Natural stone slabs may be polished prior to being scanned or photographed to provide a desirable aesthetic finish on the slab. The stone slabs may be polished to a matt finish using an abrasive grit size of 100 (150 μm) or below. To achieve a satin finish, generally abrasive grit sizes of 100-400 grit (150 μm-38 μm) are used. A semi-gloss or semi-polished look is achieved using 400-800 grit (38 μm-15 μm) abrasive, and a gloss finish is achieved using an abrasive grit size from 800-3000 (15 μm-5 μm). Polishing may be done in a series of sequential steps, each using a progressively smaller particle size abrasive grit and each removing scratch marks from the previous polishing grit pass.

In an alternate embodiment of an improved decorated article 100, the subject of decorative image 150 is one or more natural plant based materials, including bark, heartwood, sapwood, stems, roots, leaves, flower buds, flowers, seeds, and seed heads and the like. In some embodiments, decorative image 150 may incorporate images of one or more whole plants. In alternate embodiments, decorative image 150 may be include an aesthetic arrangement of plant parts such as leaves and flowers. In some embodiments, decorative image 150 may be of one or more timber woodgrain portions.

In an alternate embodiment, the subject of decorative image 150 may include natural animal based materials, such as an animal's face or fur, skin, feathers, scales, and the like.

In an alternate embodiment, decorative image 150 may include at least one manufactured material such as concrete, synthetic stone, manufactured wood materials, metal, polymer, composite materials, textiles, ceramics and the like.

In an alternate embodiment, improved decorated article 100 comprises decorative image 150 selected from at least one of the group comprising figurative art, abstract art, digital art, cartoons, text, symbols, regular shapes, and irregular shapes.

In one embodiment, decorative image 150 comprises a tessellated arrangement of one or more smaller images to form a single composite decorative image. A tessellated arrangement may be of one image used many times, or many different images, each used once or more than once. In one embodiment, where multiple different images are used, each image may be disposed randomly in the arrangement, or may be disposed in a regular arrangement, or may be organised to form part of a larger pattern based on colour, shape, and the like. In an alternate embodiment, decorative image 150 comprises a single image of one or more materials.

Traditionally, if a cut and polished slab of granite is used as a cladding material, or a manufactured substrate is produced and finished by applying a high resolution image either by printing or laminating, in either case the main face is coated with a protective clear coat either in a factory or onsite. Either a low gloss coating is used to match the reflectivity of the matrix resulting in dulling of any visually distinctive features such as reflective mineral grains. Alternatively, a high gloss coating is used which makes the entire surface reflective and any visual distinctiveness of reflective mineral grains relative to the matrix minerals is lost. The present disclosure provides a method of overcoming these limitations and provides an improved decorated article 100.

In the present disclosure, each decorative image 150 comprises at least one second image area 156 which provides an aesthetic highlight for creating decorative effect 210 in an improved decorated article 100. In an image of a stone material, for example, second image area 156, in the form of one or more mineral grains, veins or inclusions, are distributed in a contrasting matrix portion providing a first image area 154 that forms a less visually distinct “background”. For example, granite is an igneous rock in which each of the minerals has different optical properties such as colour, opacity and reflectivity. Granite has visible grains of reflective minerals, such as quartz and mica, in a matrix predominantly composed of less reflective feldspathic minerals. This creates visually distinct highlights which each form a second image area 156 in decorative image 150.

A short description follows of the traditional use of selection layers in manipulation of a decorative image for printing a composite or modified image. A selection layer, by default, has the same dimensions as the original or “parent” decorative image. Selection layers in image editing software are created in black and white, which are equivalent to “background” and “foreground” respectively.

When first created, a selection layer will show in the editing pane in the image editing software, as a white shape of the same dimensions as the decorative image layer. The default setting for selection layers is that the “foreground” colour is set to white which will allow printing of any part of the original image that underlays it, and the “background” colour is set to black which will “mask” anything underlaying it in the original image and prevent it from printing.

In traditional photo-editing technology, digital selection layers provide a non-destructive way to hide or modify parts of an image in order to change the appearance of the without physically altering the original image.

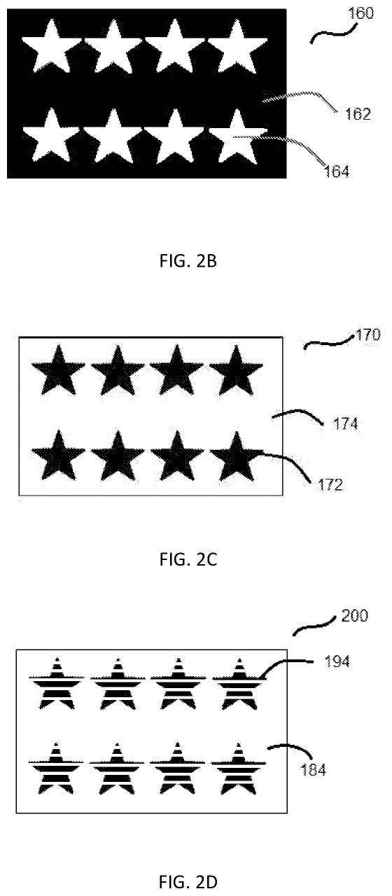

In the present disclosure, selection layers are not used in the traditional way, to alter or modify a printable image, but rather they are each used to generate a separate printable image, that can be used to control the placement of clear coating layers, superimposed on and corresponding to specific areas or features in the decorative image layer, such as matrix portion or discrete decorative elements. For example, as best shown in FIG. 2A, if decorative image layer 152 comprises a series of geometric star shapes 156 dispersed in a contrasting colour background or matrix 154, a first digital selection layer 160 can be created as shown in FIG. 2B, in which first image area 162 is selected and the “foreground” and “background” colours are selected such that the “foreground” colour is represented as black. First digital selection layer 160 can be used to control and direct the application location of first clear coating composition 180 to form first clear coating layer 182.

Similarly, as shown in FIG. 2C, second digital selection layer 170 can be created and at least one of the star shapes selected to create second selected portion 172. In second digital selection layer 172, the “foreground” and “background” colours are again selected such that second selected portion 172 is shown in black. Second digital selection layer 170 can be used to control and direct the application locations of second coating composition 190 to form second clear coating layer 192 superimposed on and corresponding to discrete decorative elements forming second image area 156.

First digital selection layer 160, second digital selection layer 170, and any subsequent digital selection layer 170′ together correspond to the full area of digital image 150. The dimensions of decorative image 150 remain unchanged by the creation of the digital selection layers, so edge locations correlate and application of first clear coating layer 182 is controlled such that, when applied to the prepared substrate, first clear coating layer 182 is superimposed over first image area 154 of decorative image 150 and each discrete d

In this design, when printed onto an article, the first clear coating the second clear coating can be applied specifically superimposed on those areas in the decorative image layer 152 that correspond to the geometric star shapes. By curing the first clear coating to a matte or low gloss finish and curing the second clear coating to a higher gloss finish, the authenticity of the finished article's appearance is improved and visual aesthetic features such as 3D effect and depth perception of each discrete decorative element can be enhanced.

The use of digital selection layers allows one or more clear coatings to be applied to specific locations on a printed decorative image and cured to different gloss levels to provide an enhanced and improved decorated surface finish to an article such as a building product. When more than one clear coating is applied over a decorative image, the areas to which each clear coating is applied are controlled such that the clear coatings substantially do not overlap. One benefit of this is that there are no step height changes in the surface, as there would be if one clear coating is applied to the whole surface and a second coating applied to specific locations on top of the first coating.

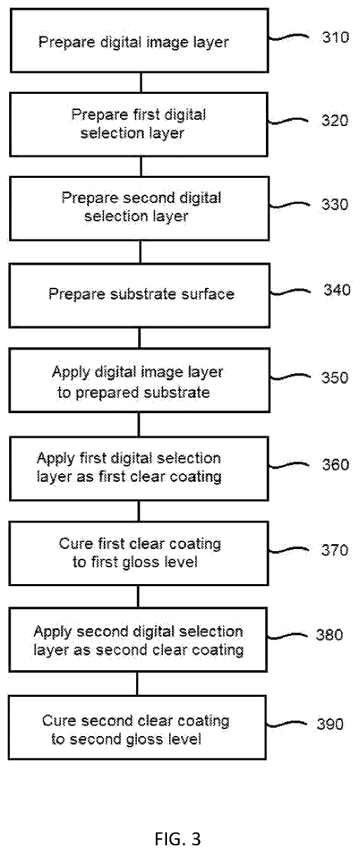

As best shown in FIG. 3, there is provided a method of making an improved decorated article 300, in which step 310 comprises preparing decorative image layer 152 by sourcing or creating an image in digital format and uploading to an image editing software program and editing or modifying as needed. The source image file can be modified to suit the users requirements by any normal image editing means, such as cropping, editing colours, lighting, and the like.

Once the image has been prepared, it is ready for use as decorative image layer 152. Decorative image layer 152 has a finite area sized to suit the area that needs to be applied to an article to provide a decorative finish. Decorative image layer 152 may be applied as a single image, or may be applied as multiple discrete images, or tiled to provide a mosaic of smaller images that combine to cover the desired portion of an article's surface.

Once the fundamental properties of the decorative image have been edited, at least two separate and complementary digital selection layers are created, first digital selection layer 160 and at least second digital selection layer 170, are prepared from decorative image layer 152 using image editing software capable of creating selection layers. Each digital selection layer created is separate from, and does not alter, the visible image of decorative image layer 152.

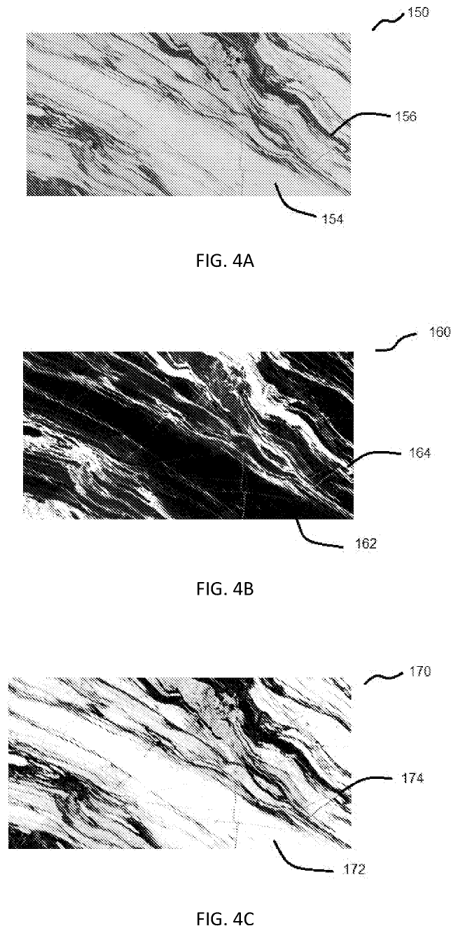

As shown in FIG. 4A, an example image, in this case an image of a polished slab of a veined marble, is created and edited as needed to prepare decorative image layer 152. In this instance, the image in FIG. 4A is shown in black and white, but can be a full colour image, a predominantly single colour image, symbols or text on a contrasting background, and so on, as desired. The image is cropped, stretched or resized to provide an image having a finite area of desired size.

In method step 320, the selection layer tool in the image editing software package is chosen and a digital layer is formed that displays as a white panel in the editing controls. An area of decorative image layer 152 corresponding to first image area 154 is highlighted to prepare first digital selection layer 160, shown in FIG. 4B. This can be done by using a user defined criteria to select a portion of the image meeting the criteria, such as by choosing all pixels within a band of grey scale or colour, physically selecting an area, or by any other desired means selecting first image area 154 of decorative image layer 152 corresponding to the matrix area of the image. The white “foreground” and black “background” colours of first digital selection layer 160 may be swapped so that the “foreground” colour in first digital selection layer 160 is black and first digital selection layer 160 can be later used to direct and control the area to apply a first clear coating.

In method step 330, the selection layer tool in the image editing software is chosen again and a second digital layer is formed that displays as a white panel in the editing controls. A second area of decorative image layer 152 is selected corresponding to second image area 156 is highlighted to prepare second digital selection layer 170. This can be done by selecting a complementary portion of digital image layer 152, representing second image area 156 containing at least one discrete decorative element. This process can be repeated where there are more than one type of discrete decorative elements present in decorative image layer 152 that may be highlighted separately in a final improved decorated article. Each second digital selection layer together combines to provide a second image area complementary to first image area 154 and first image area 154 and second image area 156 together are substantially the same as the finite area of decorative image layer 152.

The default foreground colour is switched to black for second digital selection layer 170, the complementary portions of the image, corresponding to the mineral veins in decorative image 150, were highlighted, as shown in FIG. 4C. In this example, the portion of decorative image 150 covered by first digital selection layer 160, and the complementary portions of decorative image 150 represented by second digital selection layer 170 together completely cover the finite area of decorative image 150.

In method step 340 in FIG. 3, at least first major face 112 of substrate 110, is prepared such that it is ready to receive decorative image layer 152 by printing, such as by digital printing or other suitable printing means. First major face 112 is first treated to ensure that the surface is smooth and flat and free of dust or debris. To achieve that, substrate 110 may need to be sanded or otherwise mechanically and/or chemically treated, to smoothen and flatten it, or alternatively by being cleaned of any debris by ishing, drying, de-dusting, and the like.

Cleaned or surface treated substrate 110 has at least one base coating layer 120 applied to at least a portion of first major face 112 to provide prepared substrate 114. In one embodiment, base coating layer 120 comprises at least one sealer layer 130. Sealer layers are used to change surface properties of the surface such as to seal surface porosity present on at least first major face 112 of substrate 110. Sealer layer 130 may or may not create a distinct surface layer on the substrate. Sealer layer 130 may soak into the surface and provide its functionality via subsurface properties. Water-borne emulsion based sealers, such as acrylic emulsions, water-borne epoxy sealers, silane functional emulsions and the like are useful, depending on the required properties for preparing the surface. Where applied sealer layer 130 forms a surface film, a dry film thickness per layer of 10-100 μm can be used.

In one embodiment, base coating layer 120 comprises at least one primer coating layer 140. Primer coating layer 140 may be applied as a single layer, or may be applied as first primer layer 142, second primer layer 144 and so on. Where more than one primer coating layer is applied, each may be partially cured, or fully cured, before applying any subsequent layer.

Primer layer 140 is generally a pigmented layer which may be pigmented white, or may be pigmented to any other suitable desired colour. In one embodiment, primer layer 140 comprises at least two layers, each pigmented to a different colour. In an alternate embodiment, primer layer 140 comprises at least two layers, each pigmented to a different shade of a single colour. Each primer layer 140 may be applied at an equivalent dry film thickness of 15-150 μm.

Base coating layer 120 may further comprise one or more functional layers, such as an adhesion promoter layer 146, applied to sealer layer 130 prior to application of primer layer 140, for improving bonding between sealer layer 130 and primer layer 140. Alternatively, adhesion promoter layer 146 may be applied to primer layer 140 for improving bonding to any subsequently applied layers.

In method step 350, decorative image 150 is printed onto prepared substrate 114, preferably using a digital printer such as an inkjet printer capable of printing with multiple colour inks to provide a printed decorative image layer 152.

Inks suitable for digital printing can be water borne, solvent borne or UV curable, depending on the intended application. Where the article to be manufactured is an improved decorated article, particularly for use as an exterior cladding material, UV curable inks are generally preferred for their durability and resistance to fading. When using UV curable inks, digital image layer 152 is preferably printed onto prepared substrate 114 at a line speed of at least 10 metres/minute and cured by exposure to UV lamps that provide sufficient UV radiation dose rate to initiate and complete curing reactions. Generally, manufacturers recommend a dose rate of 300 mJ/cm² or more for complete cure.

Digital printing, such as inkjet printing may be done in a single pass with multiple printheads, each delivering a single colour composition, or may be done in multiple passes with a single colour applied in each pass.

In method step 360, first clear coating composition 180 is applied in one or more predetermined locations, defined by first selected portion 162 of first digital selection layer 160, superimposed on corresponding to first image area 154 of decorative image layer 152.

In method step 370, first coating composition 180 is cured to form a first clear coating layer 182 providing first top surface 184 having first gloss level 186. If first coating composition 180 is a radiation curable composition, then it is curable by exposure to radiation. If first coating composition 180 is UV curable, then exposure to radiation from lamps that emit wavelengths of light in the UV region can be used. Lamp types include mercury, metal halide, LED,

In one embodiment, first clear coating layer 182 is at least partially cured prior to any subsequent coating layers being applied. In one embodiment, first clear coating layer is fully cured prior to any subsequent clear coating layer 192 being applied. First clear coating layer 182, second clear coating layer 192 and any subsequent clear coating layer 192′ do not substantially overlap. The thickness of first clear coating layer 182 and of second clear coating layer 192 are substantially similar so that, when fully cured, there is no substantial height difference between first top surface of first clear coating layer 182, and second top surface 194 of second clear coating layer 192. First clear coating layer 182 and second clear coating layer 192 (and any subsequent clear coating layer 192′) together provide complete coverage of the finite area of decorative image layer 152.

In method step 380, second clear coating composition 190 is applied to at least one predetermined location defined by second selected portion of second digital selection layer 170 to form second clear coating layer 192.

In method step 390, the applied second clear coating layer 192 is then at least partially cured to form a second top surface 194 having second gloss level 196. Where this is the last step in method 300, the second clear coating layer 192 and any previously applied and partially cured coating layers are fully cured to ensure maximum durability.

Optionally, if there are multiple discrete decorative elements, method steps 380 and 390 can be repeated to apply subsequent clear coating layers and curing to predetermined gloss levels.

In one embodiment, all second image areas are defined by a single digital selection layer. Second clear coating layer 192 is cured to second gloss level 196 which is different to, and higher than, that of first gloss level 186 of first clear coating layer 182.

In one embodiment, all second image areas are defined by a single digital selection layer. Second clear coating layer 192 is cured to second gloss level 196 which is different to, and higher than, that of first gloss level 186 of first clear coating layer 182.

In an alternate embodiment, more than two digital selection layers are created, and second digital selection layer 170 and each subsequent digital selection layer 170′ comprises a subset of the second image areas in decorative image 150. Each second clear coating layer 192′ applied to decorative image layer 152 using instructions from second digital selection layer 170, and is cured to provide a second gloss level 196 different to that of first gloss level 186 of first clear coating layer 182.

In one embodiment, first clear coating composition 180 and second clear coating composition 190 are the same and are supplied to a single printhead for application to the prepared substrate over each respective portion of digital image layer 152 to form first clear coating layer 182 and second clear coating layer 192 respectively. First clear coating layer 182 and second clear coating layer 192 are each fully cured immediately after application and each is cured under different conditions to provide different gloss levels.

In one embodiment, first clear coating composition 180 and second clear coating composition 190 have different compositions and are each supplied to a respective print head for application to the prepared substrate over each respective portion of digital image 150 and cured under the same or different conditions to provide different gloss levels.

In one embodiment, at least one second image area 156 of improved decorated article 100 has an irregular shape. For example, in an image of a manufactured stone material such as terrazzo, each second image area 156 is an irregular shape. Similarly, in a natural stone material such as marble, granite, and the like, each second image area 1 . . . is in the form of an irregularly shaped mineral inclusion.

In one embodiment, at least one second image area 156 has a regular shape. For example, a regular geometric shape such as a circle, square, triangle, polyhedron, and the like. In one embodiment, a plurality of second image areas are arranged in a repeating pattern.

In one embodiment, decorative image 150 may be a single image sized to cover the entire first major face 112 of prepared substrate 114. In an alternate embodiment, decorative image 150 is in the form of an image that is mosaiced together with other images or with other copies of itself to form a tessellated image that is applied to cover the entire first major face 112 of prepared substrate 114.

In one embodiment, the gloss level of the second clear coating layer is higher than the gloss level of the first clear coating layer. In one embodiment, the first gloss level 186 of the cured first clear coating layer 182 is less than 20 Gloss Units, thereby providing a predominantly matte finish to first image area 154 of an improved decorated article.

### Example 1

Decorative digital image layer 152, as shown in FIG. 4A, is created separately by high resolution, large format scanning of a natural slab of marble that had been polished to an overall satin finish using a final polish with a 400 grit abrasive. The scan provided an image file in a digital format, suitable for post-processing such as image editing in an image editing software package.

The original marble slab comprises a portion of the face of the slab that forms the background or matrix of the appearance of the stone slab, and at least one portion that forms a visually distinct second image area in the overall appearance. In the image of marble slab shown in greyscale in FIG. 4A, the image has a first image area 154 providing a matrix portion of predominantly white and light to mid grey tones, and a plurality of second image areas 156 each in the form of a discrete vein of dark or black minerals that are more reflective and appear to have a higher gloss level than the matrix and each providing a discrete decorative element.

Once created by digital scanning of the stone slab, the decorative image is uploaded to an in image editing software package such as Adobe's Photoshop where pre-processing such as sizing, colour corrections, lighting corrections and the like are applied to optimise the required aesthetics of the image. The processed image is saved in digital format on a computer, and when loaded into an image editing software package, provides digital image layer 152.

A substrate, such as a fibre cement panel or the like, provides a sufficiently strong, flexible and durable material having the required physical properties necessary for use in the manufacture of an improved decorated article according to the present disclosure. In this example, a 1200 mm×2400 mm fibre cement panel, having a thickness of 8 mm+/−0.5 mm, is used as substrate. The first major face 112 of the panel is sanded to provide a smooth, flat face and then de-dusted by brushing.

A composite base coating layer 120 is applied to provide an optimised durable, flat, smooth prepared surface suitable for application of a decorative finish. Composite base coating layer 120 comprises a sealer layer 130, at least one primer layer 140, and optional functional layers such as adhesion promotion layer 146.

Composite base coating layer 120 comprising sealer layer 130, and primer layer 140 are applied and cured. Sealer layer 140, comprising a water based acrylic emulsion, is applied to first major face 112 at between 10 μm and 30 μm dry film thickness equivalent and dried to fully cure the sealer.

Primer layer 140, comprising a water based acrylic emulsion coating layer, is applied at approximately 15 μm-50 μm dry film thickness equivalent in a single pass and fully cured by drying. In this example, base coating layer 120 is pigmented white to provide the highest level of support for first image area 154 and provide the greatest contrast with each mineral vein forming a respective discrete second image area 156.

Decorative image layer 152 is applied to prepared substrate 114 by digital printing, using Mimaki brand inkjet printer, configured with 6 print heads, of which each of four printheads prints one of four colour inks (CYMK) at 600 dpi resolution.

First clear coating composition 180 is applied by the fifth print head to form first clear coating layer 182 superimposed over decorative image layer 152, to those corresponding portions of decorative image 150 representing first image area 154. First clear coating layer 182 is fully cured to provide a matt finish appearance with a gloss level below 20 Gloss Units. Gloss levels of lower than or equal to 20 Gloss Units were desired in those portions of decorative image 150 representing the marble's matrix, and provide a matt finish aesthetic that consumers prefer.

Second clear coating layer 192 is applied, superimposed over decorative image 150 by the sixth printhead to those portions of decorative image 150 corresponding to at least one second image area 156 in the form of mineral veins. Second clear coating layer 192 is cured to a gloss finish having an average gloss level above 20 gloss units.

TABLE 1

| | Gloss | Gloss | Gloss |
|---|---|---|---|
| | Level @ | Level @ | Level @ |
| Area | 20 Degrees | 60 degrees | 85 Degrees |
| First image area | 1.98 | 13.59 | 13.99 |
| (Matte) | | | |
| Second image area | 71.55 | 91.19 | 88.15 |
| (Glossy) | | | |

Gloss readings, in Gloss Units, were taken at various points across first major face 112 of improved decorated building panel 100. The results are presented below in Table 1, as average values of 10 individual readings for each.

When an improved decorated article 100, such as a building panel as described in Example 1, is viewed under natural or artificial light, the difference in gloss levels between first clear coating layer 182 and second clear coating layer 192, in combination with respective visual features in decorative image layer 152 provide an enhanced decorative effect 210 whereby an enhanced reproduction of highlights in natural and/or manufactured material images, and/or digitally created images is provided. In the embodiment described in Example 1, decorative effect 210 is an improved decorative light effect providing improved contrast between the higher reflectivity discrete dark mineral veins and the lower reflectivity of a matte mineral matrix in the natural stone image. The improved contrast thereby more effectively mimics the finish of a real polished stone slab in which different mineral components will polish to different gloss levels.

The improvement in the appearance of improved decorated article 100 provided by decorative effect 210 arises from a combination of partial reflection of incident light 200 from decorative image layer 152 (including first image area 154 and at least one second image area 156) in combination with respective differentiated partial light reflection from 1^{st} gloss level 186 of first top surface 184 of first clear coating layer 182 and from second gloss level 196 of second top surface 194 of second clear coating layer 192 where first clear coating layer 182 is superimposed on first image area 154 of decorative image layer 152 and second clear coating layer is superimposed on at least one second image area 156 of digital image layer 152. The overall effect is to provide an improved level of realism in a digital printed decorated article.

Improved decorated article 100, is produced by digitally printing decorative image 150 onto prepared substrate 114 to form decorative image layer 152 and curing if necessary, then using first digital selection layer 160 to define and control the area of digital image layer 152 to which first clear coating composition 180 is applied to form first clear coating layer 182 curable such that first top surface 184 has a predetermined first gloss level 186, and then using second digital selection layer 170 to define complementary portions of decorative image layer 152 to which second clear coating composition 190 is applied to form second clear coating layer 192 and curable such that second top surface 194 has second gloss level 196 higher than first gloss level 186, and where second clear coating layer 192 is superimposed on respective portions of printed decorative image layer 152 corresponding to at least one second image area 156 to form decorative effect 210.

It will of course be understood that the invention is not limited to the specific details described herein, which are given by way of example only, and that various modifications and alterations are possible within the scope of the disclosure as defined in the appended claims.

Certain features that are described in this disclosure in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as ‘can’, ‘could’, ‘might’, or ‘may’, unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase ‘at least one of X, Y, and Z’ unless specifically stated otherwise, is otherwise understood with the context as used in general to convey that an item, term, etc. may be either X, Y or Z. Thus, such conjunctive language is not generally intended to imply that certain embodiments require the presence of at least one of X, at least one of Y, and at least one of Z.

Language of degree used herein, such as the terms ‘approximately’, ‘about’, ‘generally’ and ‘substantially’ as used herein represent a value, amount, or characteristic close to the stated value, amount or characteristic that still performs a desired function or achieves a desired result. For example, the terms ‘approximately’, ‘about’, ‘generally’ and ‘substantially’ may refer to an amount that is within less than or equal to 10% of, within less than or equal to 5% of, within less than or equal to 1% of, within less than or equal to 0.1% of, and within less than or equal to 0.01% of the stated amount.

Although making and using various embodiments are discussed in detail below, it should be appreciated that the description provides many inventive concepts that may be embodied in a wide variety of contexts. The specific aspects and embodiments discussed herein are merely illustrative of ways to make and use the systems and methods disclosed herein and do not limit the scope of the disclosure. The systems and methods described herein may be used in conjunction with providing an improved decorated article and are described herein with reference to this application. However, it will be appreciated that the disclosure is not limited to this particular field of use.

Some embodiments have been described in connection with the accompanying drawings. The figures are drawn to scale, but such scale should not be limiting, since dimensions and proportions other than what are shown are contemplated and are within the scope of the disclosed inventions. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practised using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

1. A method of manufacturing an improved decorated article, comprising:
(a) preparing a decorative image in digital format comprising:
i. preparing a decorative image layer comprising a first image area defining a matrix portion, and at least one second image area, each second image area defining a discrete decorative element, the first image area and each second image area together defining a finite image area;
ii. creating a first digital selection layer, and defining a first selected portion corresponding to the first image area of the decorative image layer; and
iii. creating at least one second digital selection layer and defining at least one second selected portion, each second selected portion corresponding to the discrete decorative element in the decorative image layer, and together corresponding to the second image area of the decorative image layer;
wherein the first selected portion of the first digital selection layer and the second selected portion of the second digital selection layer together correspond to the finite image area of the decorative image layer;
(b) providing a prepared substrate comprising at least a first major face,
(c) digitally printing the decorative image layer to at least a portion of the first major face;
(d) using the first selected portion of the first digital selection layer to direct application of a first clear coating layer onto the prepared substrate, superimposed on and corresponding to, the first image area, and curing the first clear coating layer to a first gloss level; and
(e) using each second selected portion of the at least one second digital selection layer to apply a second clear coating layer onto the prepared substrate, superimposed on and corresponding to, the second image area, and curing the second clear coating layer to a second gloss level.

2. The method according to claim 1, wherein the cured first clear coating layer has a different gloss level to the cured second clear coating layer, and any subsequent clear coating layer.

3. The method according to claim 1, wherein the first clear coating layer is cured to a lower gloss level than the second clear coating layer.

4. The method according to claim 1, wherein the first clear coating layer is cured to a gloss level less than 20 Gloss Units.

5. The method according to claim 1, wherein the first clear coating layer and each second clear coating layer do not substantially overlap.

6. (canceled)

7. (canceled)

8. The method according to claim 1, wherein the first clear coating layer is curable by radiation comprising at least one wavelength in a range of 250 nm-450 nm.

9. An improved decorated article comprising:
(a) a prepared substrate comprising at least a first major face;
(b) a decorative image layer applied to at least a portion of the first major face, the decorative image layer comprising a first image area and at least one second image area;
(c) a first digital selection layer and at least one second digital selection layer;
(d) a first clear coating layer applied to the first image area and cured to a first gloss level; and
(e) at least one second clear coating layer applied to at least one discrete location on the at least one second image area of the decorative image layer and cured to a second gloss level, characterized in that the first clear coating layer is applied to a location defined by a first selected portion of the first digital selection layer and the second clear coating layer is applied to at least one discrete location, each discrete location defined by a second selected portion of the at least one second digital selection layer, and each second clear coating layer is superimposed over a respective corresponding second image area;
wherein when the improved decorated article is viewed under natural or artificial light, incident light partially penetrates both second clear coating layer and the first clear coating layer and is reflected off the at least one second image area of the decorative image layer, and incident light is partially reflected from the second clear coating layer, the combined reflected light providing a decorative effect to visually distinguish the at least one second image area from the remainder of decorative image.

10. The improved decorated article according to claim 9, wherein the decorative image comprises a natural material.

11. The improved decorated article according to claim 10, wherein the natural material is a natural stone.

12. (canceled)

13. The improved decorated article, according to claim 10, wherein the decorative image is plant based, the plant based decorative image is selected from the group consisting of bark, woodgrain, stems, roots, leaves, flowers, seeds, and seed heads.

14. (canceled)

15. The improved decorated article according to claim 9, wherein the decorative image comprises a manufactured material.

16. The improved decorated article according to claim 15, wherein the manufactured material is selected from the group consisting of concrete, synthetic stone, metal, polymer, composite materials, textiles, and ceramics.

17. The improved decorated article according to claim 9, wherein the decorative image is selected from the group consisting of figurative art, abstract art, digital art, cartoons, text, symbols, regular shapes, and irregular shapes.

18. The improved decorated article according to claim 9, wherein the first clear coating layer is applied in a predetermined pattern.

19. The improved decorated article according to claim 9, wherein the second clear coating layer is applied in a predetermined pattern.

20. The improved decorated article according to claim 18, wherein each predetermined pattern is a subset of decorative elements in the decorative image layer.

21. (canceled)

22. (canceled)

23. The improved decorated article according to claim 9, wherein the second gloss level of the second clear coating layer is higher than the first gloss level of the first clear coating layer.

24. (canceled)

25. The improved decorated article according to claim 9, wherein the prepared substrate is a building product.

26. An improved decorated article according to claim 25, wherein the building product is formed from fiber cement.

27. The improved decorated article according to claim 13, wherein the plant based decorative image is a woodgrain decorative image.
